(19) United States
(12) Patent Application Publication
(10) Pub. No.: US 2019/0118360 A1
(43) Pub. Date: Apr. 25, 2019

(54) APPARATUS FOR DRIVING AND EXTRACTING PEGS

(71) Applicant: GMS SOLUTIONS SPA, Puerto Natales (CL)

(72) Inventor: Guillermo Patricio MUÑOZ SOTO, Puerto Natales (CL)

(73) Assignee: GMS SOLUTIONS SPA

(21) Appl. No.: 15/793,278

(22) Filed: Oct. 25, 2017

(51) Int. Cl. B25D 1/04; E04H 17/26

(52) U.S. Cl. CPC B25D 1/04; E04H 15/62; E04H 17/263

(57) ABSTRACT

An apparatus for driving and extracting pegs comprising: a proximal surface having a blind hole, said blind hole having a cross section with a complementary shape to the upper portion of said peg; a distal surface, opposed to said proximal surface, having an ergonomic shape in relation to the hand of a user, and a notch in a lateral portion of said apparatus, said notch having a cross sectional area greater than the cross sectional area of said peg, said notch also having a bridge joining two opposed surfaces of said notch.

According to the previous description, it is possible to obtain an apparatus that solves the problem of driving and extracting pegs without using a striker and that, at the same time, allows a complete driving of the peg.

### TECHINCAL FIELD OF THE INVENTION

The present invention is related to the field of hand-held tools, more specifically to hand-held nailing or strapling tools and in particular provides an apparatus for driving and extracting pegs.

### BACKGROUND OF THE INVENTION

In the previous art, in general, there are described tools and apparatuses for driving pegs which working is based on hitting the peg, therefore producing its driving. However, said working mode can produce hardly reversible deformations on the pegs, or, in some cases, produce a breaking or fracture of the same.

In order to solve said problem, in the previous art apparatuses have been proposed which allow to drive a peg without a striker element. For example, the document GB 2390563 describes an apparatus for driving and extracting a peg comprising a long handling having a curved surface and an opposed surface. In the opposed surface there is a bar having a piece adapted to the shape of the peg in the far extreme of said bar, related to said opposed surface. Said adapted piece allows to hang the peg for driving or extracting said peg. However, said apparatus does not allows the whole driving of the peg, because the adapted piece occupies a long part of the extension of said peg.

In consecuence, it is required an apparatus for driving and extracting pegs that does not use a striker element and, at the same time, that allows a complete driving of the peg.

### SUMMARY OF THE INVENTION

The present invention provides an apparatus for driving and extracing a peg, comprising: a proximal surface having a blind hole, said blind hole having a cross section with a complementary shape to the upper portion of said peg; a distal surface, opposed to said proximal surface, having an ergonomic shape in relation to the hand of a user, and a notch in a lateral portion of said apparatus, said notch having a cross sectional area greater than the cross sectional area of said peg, said notch also having a bridge joining two opposed surfaces of said notch.

In a preferred embodiment, the apparatus has a slot in a lateral portion of the same, said slot having an opening whose separation is greater than the thickness of said peg, and wherein said slot includes a cleaning material in its inner.

In another preferred embodiment, said proximal surface is detachably connected to said distal surface. In a further preferred embodiment, said detachable connection is a male-female connection. In another further preferred embodiment, said detachable connection is provided by a pair of opposed rails.

In an additional preferred embodiment, the portion of the proximal surface having said blind hole is detachably connected to said proximal surface. In a further preferred embodiment, said detachable connection is provided by a pair of opposed rails.

In another preferred embodiment, said proximal surface also includes a section for openning bottles.

In an additional preferred embodiment, said proximal surface has a plurality of blind holes, each of them having a cross section with a complementary shape to the upper portion of a kind of peg

### BRIEF DESCRIPTION OF THE DRAWINGS

FIG. 1 shows a persepective view of a first embodiment of the apparatus for driving and extracting a peg of the present invention.

FIG. 2 shows a bottom view of a first embodiment of the apparatus for driving and extracting a peg of the present invention.

FIG. 3 shows a first side view of a first embodiment of the apparatus for driving and extracting a peg of the present invention.

FIG. 4 shows a second side view of a first embodiment of the apparatus for driving and extracting a peg of the present invention.

### DETAILED DESCRIPTION OF THE INVENTION

Following, the invention will be described making reference to the accompanying drawings. Although the drawing show a preferred embodiment of the invention. A person ordinarily skilled in the art will note that other embodiments of the invention are possible without affecting the desired protection.

Essentially, the present invention presents an apparatus (1) for driving and extracting a peg comprising: a proximal surface (2) having a blind hole (3), said blind hole (3) having a cross section with a complementary shape to the upper portion of said peg; a distal surface (4), opposed to said proximal surface (2), having an ergonomic shape in relation to the hand of a user; and a notch (5) in a lateral portion of said apparatus (1), said notch having two opposite surfaces (5a, 5b) of a separation greater than the cross section of said peg, said notch also having a bridge (6) joining said opposite surfaces (5a, 5b) of said notch (5).

Regarding the proximal (2) and distal (4) sufaces, the same are named in this way because of the way in which they are related to the peg to drive. Nevertheless, it is to be understood that said names do not imply a predefined orientation or arrangement of the apparatus (1) of the present invention, but they are used for a better understanding of the invention without limiting the scope of the same. On the other hand, when a lateral portion of the apparatus (1) is named, said mention is made considering that the apparatus (1) is arranged as it normally would be used when driving a peg, that is, with the proximal surface (2) facing down and the distal surface (3) facing up. As in the previous case, this mention does not imply a preferred orientation or arrangement of the apparatus (1) but it is provided for a better understanding of the present invention, without limiting the scope of the same.

Regarding the proximal surface (2), even though in the drawing the same appears as sustantially flat, the specific shape of said proximal surface (2) does not limit the scope of the present invention. As a way of example, without limiting the scope of the present invention, it is possible to use a proximal surface (2) having a slightly concave shape to contribute that the peg to converge to the portion of said proximal surface (2) having the blind hole (3).

Additionally, the proximal surface (2) has a blind hole (2) as seen in FIG. 2. Said blind hole (3) has a cross section with a complementary shape to the upper portion of a peg. It is to be understood as a complementary shape one with which the upper portion of the peg can form a male-female pair. For example, without limiting the scope of the present invention, in the case of a standard peg, said blind hole (3) has a croos section of rectangular shape; in the case of a V shaped peg, said blind hole (3) has a cross section having a shape of star or chevron. A person ordinarily skilled in the techincal field will note that each kind of peg has a complementary shape for its upper portion.

In a preferred embodiment, not shown in the drawings and without limiting the scope of the present invention, the proximal surface (2) has a plurality of blind holes (3), each of said blind holes (3) having a cross section with a complementary shape to the upper portion of a kind of peg. The previous embodiment is particularly beneficial as it allows a single apparatus (3) according to the present invention with different kind of pegs. Nevertheless, in another preferred embodiment of the present invention, without limiting the scope of the same, the portion of said proximal surface (2) having the blind hole (3) can be detachably connected to said proximal surface (2). Said detachable connection can be obtained, for example and without limiting the scope of the present invention, by a pair of opposed rails, male-female connection, magnet connections, threaded connections or another kind of connections known in the previous art. The previous case allows, for example and without limiting the scope of the present invention, to have a plurality of portions of said proximal surface (2) having different blind holes (3) to allow an interchange of said portions.

On the other hand, regarding the distal surface (4), the shape of the same can be of any ergonomic shape in relation to the palm of the hand of a user. For example, without limiting the scope of the present invention, said distal surface (4) can have a completely convex shape that adapts to the palm, a shape of half cylinder, or other ergonomic shapes known in the previous art. In a preferred embodiment, without limiting the scope of the present invention, said distal surface (4) can be reticulated or have a non-slip surface, both in the whole of the same or in a portion of the same, in order to facilitate the handling of the apparatus (1) of the present invention.

The way in which said proximal (2) and distal (3) surfaces are related does not limit the scope of the present invention. For example, without limiting the scope of the present invention, the apparatus (1) can be limited to said proximal (2) and distal (3) surfaces, or can include other components in association with the same. In a preferred embodiment, without limiting the scope of the present invention, said proximal (2) and distal (3) surfaces can be integrated in a single piece. However, in another preferred embodiment, without limiting the scope of the present invention, said proximal surface (2) is detachably connected to said distal surface (4). Said detachable connection can be obtained, without limiting the scope of the present invention, by a pair of opposed rails, male-female connections, magnet connections, threaded connections, as well as other kinds of connection known in the previous art. The previous case allows, for example and without limiting the scope of the present invention, to define a hollow space between said proximal (2) and distal (3) surfaces. Said hollow space can be used, for example and without limiting the scope of the present invention, to keep small objects, coins, camping instruments, among others.

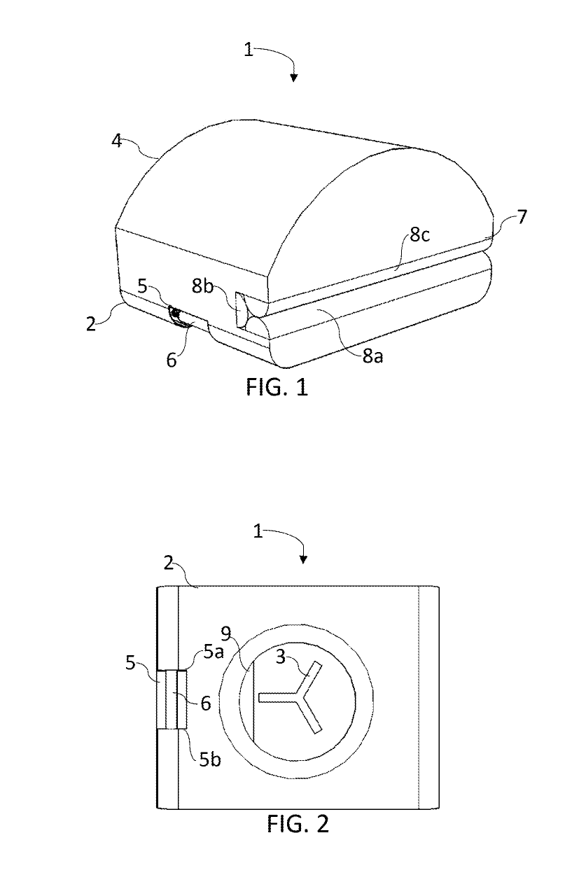

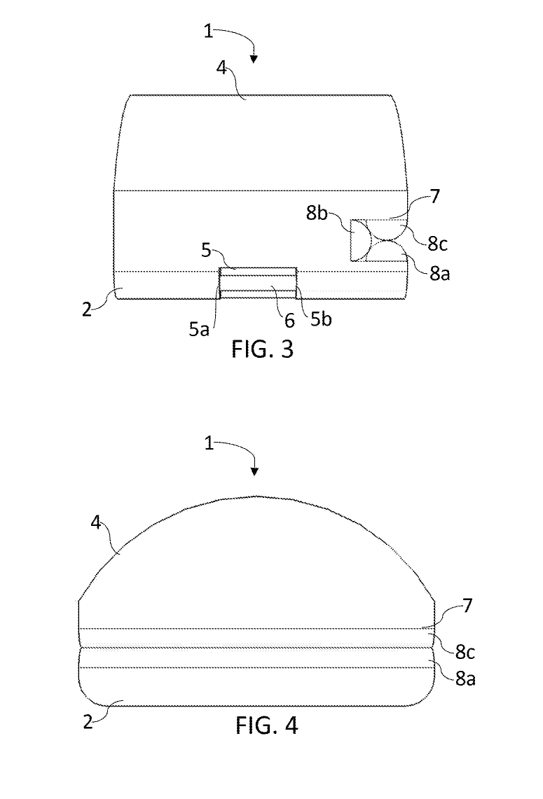

Regarding the notch (5), the same is shown in FIG. 1, FIG. 2 and FIG. 3 and is located at a lateral portion of the apparatus (1) of the present invention. Said notch (5) has two opposed surfaces (5a, 5b), whose separation is greater than the cross section of the peg to drive or extract. Said notch (5) has, additionally, a bridge (6) joining said opposed surfaces (5a, 5b) of said notch (5). The group formed by the notch (5) and the bridge (6) has the objective of work as a portion of the apparatus (1) for extracting the peg, hooking the upper portion of said peg. In this way, without limiting the scope of the present invention, said peg can be extracted by pulling the apparatus (1) of the present invention, making the peg to be pulled out of the ground in which the same is driven. The specific shape of said notch (5) does not limit the scope of the present invention. Additionally, the specific shape of the bridge (6) joining the opposed surfaces (5a, 5b) does not limit the scope of the present invention as long as it allows the hooking of said peg.

In a preferred embodiment, without limiting the scope of the present invention, the apparatus (1) of the present invention also comprise a slot (7) in a lateral portion of the same, as shown in FIG. 1, FIG. 3 and FIG. 4. Said slot (5) has an opening of a separation greater than the thickness of said peg and, additionally, said slot (7) includes a cleaning material (8) in its inner. Said group formed by the slot (7) and the cleaning material (8) has the objective of cleaning and/or drying the peg as it is slided by its surface, and, consequently, it is to be understood that a cleaning material (8) is that that allows to fulfill this objective, as can be, for example and without limiting the scope of the presente invention, felt, rubber, absorbent paper, sponges, and other materials known in the previous art, as well as combinations thereof. Said cleaning material (8) can or not be impregnated with an agent that eases the cleaning of the peg, without limiting the scope of the present invention. On the other hand, the specific shape of the slot (7) does not limit the scope of the present invention, being able to have a rectangular, circular, curved or other shapes. Additionally, in a preferred embodiment and as shown in the drawings, without limiting the scope of the present invention, said slot (7) can include a plurality of cleaning materials (8a, 8b, 8c) which can be of the same or different nature. In another preferred embodiment, without limiting the scope of the present invention, said slot (7) can include different kind of cleaning materials (8) along the same.

In another preferred embodiment, as shown in FIG. 2 and without limiting the scope of the present invention, the proximal surface (2) and include, additionally, a section for opening bottles (9). Said section for opening bottles (9) is widely known in the previous art and, sustantially, is formed by two opposed surfaces that allows to separate the cap from the bottle.

Regarding the material with which the apparatus (1) of the present invention is made, the same does not limit the scope of the present invention and can be, among others, plastic, rubber, wood, aluminium as well as combinations thereof.

According to the previous detailed description, it is possible to obtain an apparatus (1) that solves the problem of driving and extracting pegs without using a striker and that, at the same time, allows a complete driving of the peg.

1. An apparatus for driving and extracting a peg, comprising:
a proximal surface having a blind hole, said blind hole having a cross section with a complementary shape to the upper portion of said peg;
a distal surface, opposed to said proximal surface, having an ergonomic shape in relation to the palm of the hand of a user; and
a notch in a lateral portion of said apparatus, said notch having two opposed surfaces whose separation is greater than the cross section of said peg, said notch also having a bridge joining said opposed surfaces of said notch.

2. The apparatus of claim 1, comprising a slot in a lateral portion of the same, said slot having an opening with a separation greater than the cross section of said peg, and wherein said slot also includes a cleaning material in its inner.

3. The apparatus of claim 1, wherein said proximal surface is detachably connected to said distal surface.

4. The apparatus of claim 3, wherein said detachable connection is a male-female connection.

5. The apparatus of claim 3, wherein said detachable connection is obtained by a pair of opposed rails.

6. The apparatus of claim 1, wherein the portion of the proximal surface having the blind hole is detachably connected to said proximal surface.

7. The appartus of claim 6, wherein said detachable connection is obtained by a pair of opposed rails.

8. The apparatus of claim 1, wherein said proximal surface, additionally, has a section for opening bottles.

9. The apparatus of claim 1, wherein said proximal surface has a plurality of blind holes, each of said blind holes having a cross section of a complementary shape to the upper portion of a kind of peg.
